(19) United States
(12) Patent Application Publication
(10) Pub. No.: US 2017/0122273 A1
(43) Pub. Date: May 4, 2017

(54) FUEL TANK LID AND FUEL PUMP MODULE HAVING THE SAME

(71) Applicant: DENSO CORPORATION, Kariya-city, Aichi-pref. (JP)

(72) Inventors: Akihiro KONNO, Kariya-city (JP); Noboru NAGASE, Kariya-city (JP); Tatsuya KAKEHI, Kariya-city (JP); Kiyoshi NAGATA, Kariya-city (JP); Masahide TATSUMI, Kariya-city (JP)

(21) Appl. No.: 15/125,977

(22) PCT Filed: Mar. 26, 2015
(86) PCT No.: PCT/JP2015/001734

§ 371 Date: Sep. 14, 2016

(30) Foreign Application Priority Data
Apr. 1, 2014 (JP) 2014-075689

(51) Int. Cl. F02M 37/10; F02M 25/08; B60K 15/04; F02M 37/08

(52) U.S. Cl. CPC F02M 37/103; F02M 37/08; F02M 25/089; B60K 15/0406; F02M 2037/082; B60K 2015/0432

(57) ABSTRACT

A fuel tank lid includes a lid part closing an opening of a fuel tank, and an internal terminal electrically connecting a pump provided inside the fuel tank with a drive circuit driving the pump. The lid part includes an inserted part inserted into the opening, a storage part located outside the fuel tank and storing the drive circuit in a hollow space of the storage part, and a connection part located outside the fuel tank and connecting the inserted part and the storage part. The fuel tank lid further includes a discharge part discharging a fuel vapor that tries to travel along an interface between the internal terminal and the lid part and enter the hollow space, to an external atmosphere, and a protection part covering the portion exposed from the lid part by the presence of the discharge part to protect the portion from a liquid.

### CROSS REFERENCE TO RELATED APPLICATION

This application is based on Japanese Patent Application No. 2014-75689 filed on Apr. 1, 2014, the disclosure of which is incorporated herein by reference.

### TECHNICAL FIELD

The present disclosure relates to a fuel tank lid having a lid part and an internal terminal with a central portion covered and protected by the lid part, and a fuel pump module having the fuel tank lid.

### BACKGROUND ART

As shown in Patent Literature 1, a fuel supply device, which includes a fuel tank, a fuel pump unit installed inside the fuel tank, and a controller for the fuel pump unit, is known as prior art. The fuel supply device includes a chamber that accommodates the controller, and a lid member that covers the opening of the chamber. The lid member has a higher fuel permeability than the chamber.

In the fuel supply device disclosed in Patent Literature 1, as described above, the lid member has a higher fuel permeability than the chamber. Therefore, when fuel vapor flows into a hollow space formed by the chamber and lid member (storage part), the fuel vapor can be discharged to the external atmosphere through the lid member. However, the fuel supply device shown in Patent Literature 1 lacks a configuration that minimizes the entrance of fuel vapor into the hollow space. Therefore, there is a risk that the fuel vapor entering the hollow space may contact and damage the controller.

### PRIOR ART LITERATURES

### Patent Literature

Patent Literature 1: 3P2003-269276A

### SUMMARY OF INVENTION

In view of the problem described above, an object of the present disclosure is to provide a fuel tank lid that minimizes entrance of fuel vapor into a hollow space of a storage part, and a fuel pump module having the fuel tank lid.

According to an aspect of the present disclosure, the fuel tank lid includes a lid part closing an opening of a fuel tank, and an internal terminal electrically connecting a pump provided inside the fuel tank with a drive circuit driving the pump. The lid part includes an inserted part inserted into the opening, a storage part located outside the fuel tank and storing the drive circuit in a hollow space of the storage part, and a connection part located outside the fuel tank and connecting the inserted part and the storage part. The internal terminal has a central portion, a first end, and a second end, the central portion is covered and protected by the inserted part, the connection part, and the storage part that are made of a resin material, the first end is connected to the pump inside the fuel tank, and the second end is connected to the drive circuit inside the hollow space of the storage part. The fuel tank lid further includes a discharge part discharging a fuel vapor that tries to travel along an interface between the internal terminal and the lid part and enter the hollow space of the storage part, to an external atmosphere, and the discharge part is formed in the connection part where thickness is locally reduced such that a portion of the central portion of the internal terminal is exposed from the lid part for discharging. The fuel tank lid further includes a protection part covering the portion of the central portion of the internal terminal exposed from the lid part by the presence of the discharge part to protect the portion from a liquid.

Therefore, even when fuel vapor flows along the interface between the internal terminal and the lid part from the fuel tank into the hollow space of the storage part, the fuel vapor can be discharged to the external atmosphere through the first discharge part before reaching the hollow space of the storage part. Therefore, damage potential of the drive circuit caused by fuel vapor is reduced.

Since the first discharge part is covered with the protection part, the internal terminal is prevented from being in contact with a liquid such as water. Therefore, the possibility of failure occurring in the fuel tank lid is reduced.

### BRIEF DESCRIPTION OF DRAWINGS

The above and other objects, features and advantages of the present disclosure will become more apparent from the following detailed description made with reference to the accompanying drawings. In the drawings:

FIG. 1 is a schematic diagram illustrating a fuel pump module and an internal combustion engine;

FIG. 2 is a cross-sectional view illustrating a schematic configuration of a fuel tank lid according to a first embodiment fixedly attached to a flange;

FIG. 3 is an enlarged cross-sectional view of a region III in FIG. 2;

FIG. 4 is a cross-sectional view illustrating a metal mold;

FIG. 5 is an enlarged cross-sectional view illustrating a first variation of a protection part;

FIG. 6 is an enlarged cross-sectional view illustrating a second variation of a protection part;

FIG. 7 is an enlarged cross-sectional view illustrating a third variation of a protection part;

FIG. 8 is a cross-sectional view of the fuel tank lid, showing a variation of the position for forming a first discharge part;

FIG. 9 is a cross-sectional view illustrating a schematic configuration of a fuel tank lid according to a second embodiment fixedly attached to a flange; and

FIG. 10 is an enlarged cross-sectional view of a region X in FIG. 9.

### DESCRIPTION OF EMBODIMENTS

Hereinafter, embodiments of the present disclosure will be described with reference to the drawings.

### First Embodiment

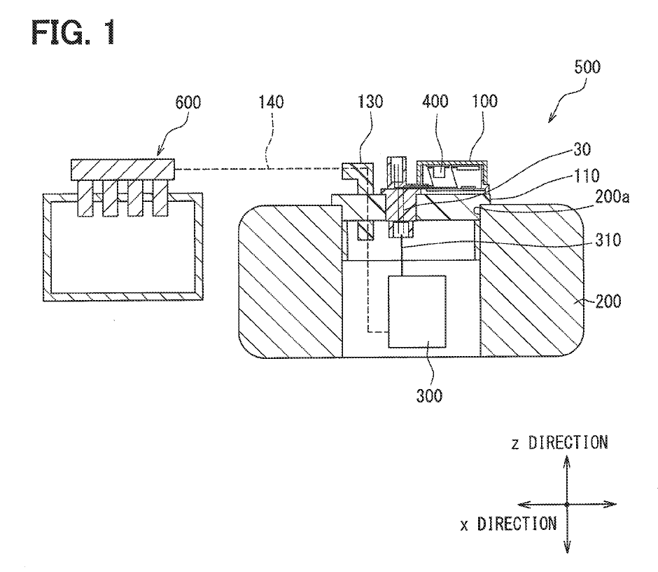

A fuel tank lid 100 according to the present embodiment will be described with reference to FIG. 1 to FIG. 4. Hereinafter, three directions orthogonal to one another will be referred to as x direction, y direction, and z direction, respectively. In the present embodiment, the z direction coincides with the vertical direction, and the x-y plane defined by the x direction and the y direction coincides with a horizontal plane.

As shown in FIG. 1, the fuel tank lid 100 is one of the components of a fuel pump module 500 mounted on a vehicle. The fuel pump module 500 includes the fuel tank lid 100, a flange 110, a fuel tank 200, a pump 300, and a drive circuit 400. The fuel tank 200 stores fuel in the hollow space of the fuel tank 200 and an opening 200a is closed by the fuel tank lid 100 and the flange 110. The pump 300 feeds fuel to an internal combustion engine 600, and is provided inside the fuel tank 200. The drive circuit 400 drives the pump 300, and is mounted to the fuel tank lid 100 outside the fuel tank 200.

As shown in FIG. 1, the pump 300 and the drive circuit 400 are electrically connected to each other via a pump drive wiring 310 and via an internal terminal 30 of the fuel tank lid 100. Fuel pumped up by the pump 300 is fed to the internal combustion engine 600 through a fuel supply pipe 130 in the flange 110, and through a fuel pipe 140 assembled to the fuel supply pipe 130. As shown in FIG. 1, the fuel pipe 140 is represented by a broken line. The opening 200a of the fuel tank 200 is positioned vertically higher than the walls that form the fuel tank 200. Therefore, vaporized fuel may be discharged from the fuel tank 200 through the opening 200a to the external atmosphere, but hardly stays around the opening 200a (around the fuel tank lid 100). In the present embodiment, vaporized fuel will be referred to as fuel vapor.

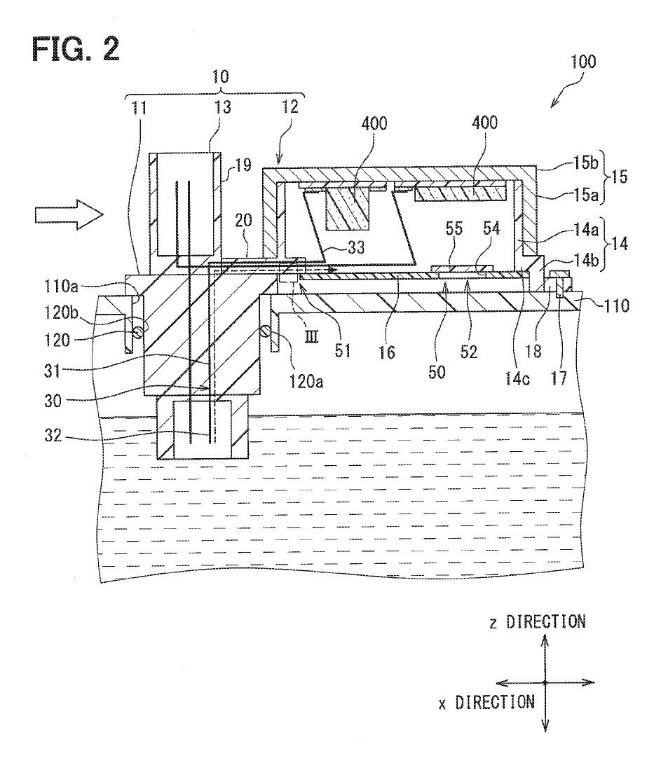

As shown in FIG. 2, the fuel tank lid 100 is provided to an opening 110a of the flange 110. An O-ring 120 is provided to the opening 110a. An outer annular surface 120a of the O-ring 120 is in contact with the rim of the flange 110 that defines the opening 110a all around, while an inner annular surface 120b is in contact with the fuel tank lid 100 all around. Thus the opening 110a of the flange 110 is closed by the fuel tank lid 100 and the O-ring 120.

The fuel tank lid 100 includes a lid part 10, the internal terminal 30, and a discharge structure 50. The lid part 10, while closing the opening 200a of the fuel tank 200 together with the flange 110, serves as the function of carrying the drive circuit 400. The lid part 10 closes a part of the opening 200a of the fuel tank 200 by dosing the opening 110a of the flange 110, as described above.

The lid part 10 includes an inserted part 11 that is inserted into the opening 110a (opening 200a), a storage part 12 that is located outside the fuel tank 200 and stores the drive circuit 400 in a hollow space in itself, and a connection part 13 that is located outside the fuel tank 200 and connects the inserted part 11 and the storage part 12. As shown in FIG. 2, the inserted part 11 extends in the z direction, the storage part 12 has a box-like shape, and the connection part 13 is L-shaped in the z-x plane defined by the z direction and the x direction. Part of the inserted part 11 is inserted into the fuel tank 200, while the rest is outside the fuel tank 200 and is exposed to the external atmosphere. The O-ring 120 mentioned above is provided between the inserted part 11 inside the fuel tank 200 and the flange 110, so as to minimize discharge of fuel vapor to the external atmosphere through the gap between the inserted part 11 and the flange 110.

The storage part 12 includes a side wall 14 that is in an annular shape, an upper closure part 15 that closes a first opening, which is positioned vertically on an upper side, of the two openings of the side wall 14 and a lower closure part 16 that closes a second opening positioned vertically on a lower side. The inserted part 11, the connection part 13, and the side wall 14 are all made of the same resin material. Here, the resin material is a polyphenylene sulfide resin, or polybutylene terephthalate resin, for example.

The side wall 14 is made of a material having a fuel vapor permeability higher than the upper closure part 15 is, and includes a first annular part 14a to which the upper closure part 15 is assembled, and a second annular part 14b to which the lower closure part 16 is assembled. The first annular part 14a has an inner diameter in the x direction shorter than that of the second annular part 14b, such that a step 14c is formed at the connecting portion between the first annular part 14a and the second annular part 14b accordance with the difference in inner diameter. A space is formed between the step 14c and the flange 110, and the lower closure part 16 is assembled to the second annular part 14b in a state where the upper peripheral surface of the lower closure part 16 faces the step 14c. As shown in FIG. 2, a space is also formed between the lower closure part 16 and the flange 110, and the space communicates with the external atmosphere. The second annular part 14b also has a screw-fastened portion 18 that receives screws 17. The lid part 10 is fastened to the flange 110 with screws 17.

The upper closure part 15 is made of a metal material such as copper or aluminum, and serves as the function of dissipating the heat generated in the drive circuit 400 to the external atmosphere. The upper closure part 15 according to the present embodiment includes an enclosure part 15a that surrounds the first annular part 14a in contact with the outer annular surface of the first annular part 14a, and a ceiling part 15b that closes the first opening of the side wall 14. The drive circuit 400 is formed by a plurality of electronic elements, at least one of these electronic elements being mounted on the upper closure part 15. In the present embodiment, all the electronic elements that form the drive circuit 400 are mounted on the upper closure part 15. In this way, contact between fuel vapor that has entered the hollow space of the storage part 12 and the electronic components of the drive circuit 400 is avoided. The lower closure part 16 is made of a material having a fuel vapor permeability higher than the upper closure part 15 is.

The connection part 13 is a female connector case in which a male connector of an external device is to be fitted. The connection part 13 includes a tubular part 19 that surrounds the male connector, has a bottom surface, and extends in the z direction, and an extension part 20 that connects the tubular part 19 with the side wall 14 and extends in the x direction. A male connector is inserted into the cavity formed by the tubular part 19. When the male connector fits in the tubular part 19, the cavity is shut out from the external atmosphere. The extension part 20 is in contact with the upper surface of a portion of the inserted part 11 exposed to the external atmosphere outside the fuel tank 200, and an outer annular surface of the side wall 14, and connects the upper surface and the outer annular surface mechanically. As shown in FIG. 1, a part of the extension part 20 is located inside the hollow space of the storage part 12 and in contact with the upper peripheral edge of the lower closure part 16 in the present embodiment.

The internal terminal 30 electrically connects the pump 300 with the drive circuit 400. The internal terminal 30 is insert-molded in the inserted part 11, the connection part 13, and the side wall 14. A central portion 31 of the internal terminal 30 is covered and protected by the inserted part 11, the connection part 13, and the side wall 14. A first end 32 is exposed from the inserted part 11 into the fuel tank 200, while a second end 33 is exposed from the side wall 14 into the hollow space of the storage part 12. The first end 32 is electrically connected to the pump 300, while the second end 33 is electrically connected to the drive circuit 400.

The discharge structure 50 includes a first discharge part 51 that minimizes entrance of fuel vapor into the hollow space of the storage part 12, and a second discharge part 52 that discharges the fuel vapor that has entered into the hollow space of the storage part 12 to the external atmosphere. There is a possibility that fuel vapor may travel up along the interface between the internal terminal 30 and the lid part 10 into the hollow space of the storage part 12 as indicated with a broken line arrow in FIG. 2. When fuel vapor contacts the electronic elements that form the drive circuit 400 inside the hollow space, the electronic elements may deteriorate as a consequence. Therefore, while the first discharge part 51 minimizes entrance of the fuel vapor into the hollow space, the second discharge part 52 discharges the fuel vapor from the hollow space to the external atmosphere.

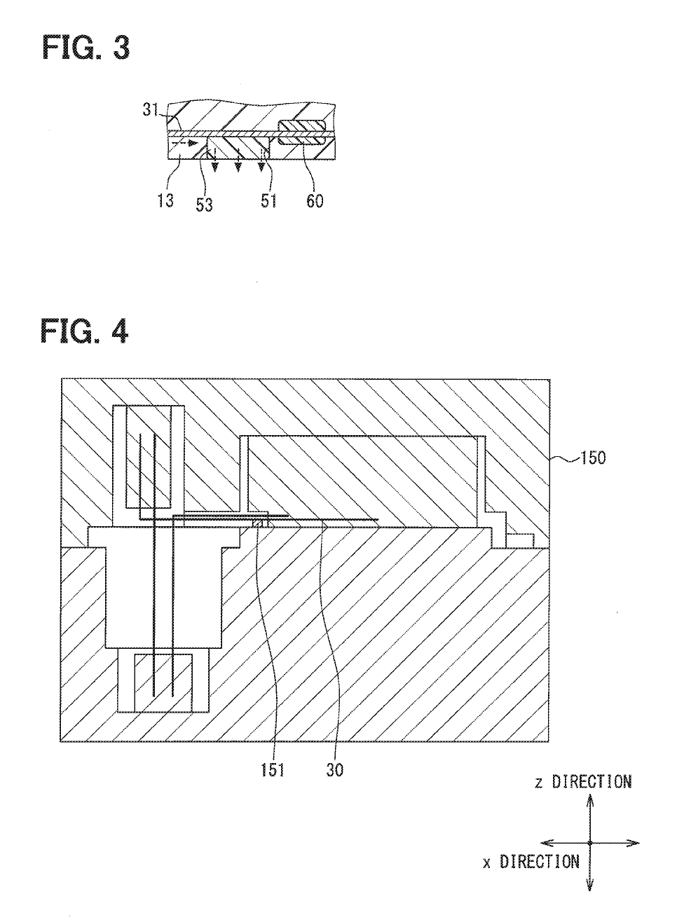

The first discharge part 51 is to discharge fuel vapor that tries to travel along the interface between the internal terminal 30 and the lid part 10 and enter the hollow space of the storage part 12. As shown in FIG. 3, the first discharge part 51 is a recess formed in the extension part 20 of the connection part 13 by locally reducing the thickness such that a part of the central portion 31 of the internal terminal 30 is exposed from the lid part 10. The space formed by the first discharge part 51 is filled with a protection part 53 such that the part of the central portion 31 exposed from the lid part 10 is covered. The first discharge part 51 in the present embodiment is made of a material having a fuel vapor permeability higher than the resin material forming the connection part 13. More specifically, the protection part 53 is an adhesive having high permeability of gasses including fuel vapor but low permeability of liquids.

The inserted part 11, the connection part 13, and the side wall 14 are made of the same resin material, and the internal terminal 30 is insert-molded in the inserted part 11, the connection part 13, and the side wall 14 as mentioned above. For the insert-molding of the internal terminal 30, the central portion 31 of the internal terminal 30 is to be placed inside a metal mold 150 for forming the inserted part 11, the connection part 13, and the side wall 14, as shown in FIG. 4. Molten resin is poured into the hollow space of the metal mold 150 to encapsulate the central portion 31. To prevent the internal terminal 30 from being displaced by the pressure of the injected resin, support pins 151 are provide in the metal mold 150. The central portion 31 is supported by the support pins 151, such that displacement of the internal terminal 30 is avoided.

Normally, the support pins 151 are pulled out from the metal mold 150 successively during the process of applying molten resin into the metal mold 150 so as to avoid creation of uncovered portions in the central portion 31 because of the support pins 151. However, as described above, the first discharge part 51 is a recess formed in the connection part 13 by locally reducing the thickness such that a part of the central portion 31 is exposed from the lid part 10. In other words, the support pin 151 located at the position where the first discharge part 51 is to be formed is not pulled out during the process of applying molten resin into the metal mold, and after the resin is cured, the cured resin is removed from the metal mold 150. The first discharge part 51 is formed in this way. In FIG. 4, only the support pin 151 that will form the first discharge part 51 is shown, and other support pins 151 are not shown.

The second discharge part 52 is a discharge port 54 formed in the lower closure part 16 positioned vertically lower than the upper closure part 15. The fuel tank lid 100 is mounted on a vehicle. The discharge port 54 is disposed in the downwind of the air flow created during driving of the vehicle as shown with a white arrow in FIG. 2. The discharge port 54 is covered with a breathable filter 5 that allows permeation of gasses including fuel vapor and not of liquids.

As shown in FIG. 3, in a portion of the central portion 31 of the internal terminal 30 closer to the storage part 12 than to the first discharge part 51, a stopper member 60 is provided, which stops the flow of fuel vapor that tries to travel along the interface between the internal terminal 30 and the lid part 10 and enter the hollow space of the storage part 12. The stopper member 60 has a stronger bond to the internal terminal 30 than to the lid part 10, and is made of a material that hardly allows permeation of fuel vapor.

Next, the advantageous effects of the fuel tank lid 100 according to the embodiment will be described. As described above, the first discharge part 51 is formed in the connection part 13 for discharging fuel vapor that tries to travel along the interface between the internal terminal 30 and the lid part 10 and enter the hollow space of the storage part 12. Therefore, even when fuel vapor flows along the interface between the internal terminal 30 and the lid part 10 from the fuel tank 200 into the hollow space of the storage part 12, the fuel vapor can be discharged to the external atmosphere through the first discharge part 51 before reaching the hollow space of the storage part 12. Therefore, damage potential of the drive circuit 400 caused by fuel vapor is reduced.

Since the first discharge part 51 is covered with the protection part 53, the internal terminal 30 is prevented from being in contact with a liquid such as water. Therefore, the possibility of failure occurring in the fuel tank lid 100 is reduced.

The protection part 53 is made of a material having a fuel vapor permeability higher than the resin material forming the connection part 13. Therefore, fuel vapor can be discharged more efficiently as compared to when the protection part is made of the same synthetic resin as that of the connection part.

The protection part 53 is made of an adhesive that allows permeation of gasses including the fuel vapor but not of liquids, and the first discharge part 51, which is a recess, is filled with the protection part 53. The connection part 13 thus has no portions where the thickness is locally reduced, such that a reduction in the mechanical strength of the connection part 13 is avoided.

In a portion of the central portion 31 of the internal terminal 30 closer to the storage part 12 than the first discharge part 51, there is provided the stopper member 60 that stops the flow of fuel vapor that tries to enter the hollow space of the storage part 12. Therefore, fuel vapor that could not be discharged to the external atmosphere through the first discharge part 51 is prevented by the stopper member 60 from entering the hollow space of the storage part 12.

The first discharge part 51 is formed by the support pin 151 of the metal mold 150. This way, the production of the fuel tank lid 100 is simplified, as compared to the method of forming the first discharge part by removing a part of the connection part by grinding after the connection part has been formed.

Since the fuel vapor is heavier than the air, the fuel vapor that has entered the hollow space of the storage part 12 accumulates from the lower closure part 16 toward the upper closure part 15. The discharge port 54 is formed in the lower closure part 16 that is positioned vertically lower than the upper closure part 15. Therefore, the fuel vapor can be discharged to the external atmosphere more efficiently as compared to a configuration where the discharge port is formed in the upper closure part. Therefore, damage potential of the drive circuit 400 caused by fuel vapor is reduced.

All the electronic elements that form the drive circuit 400 are mounted on the upper closure part 15. With this configuration, contact between fuel vapor and electronic elements can be avoided.

The opening 200a of the fuel tank 200 is positioned vertically higher than the walls that form the fuel tank 200. Therefore, unlike a configuration where the opening of the fuel tank is positioned vertically lower than the walls, stagnation of fuel vapor around the opening 200a (around the fuel tank lid 100) because of the walls is reduced.

The discharge port 54 is disposed in the downwind of the air flow created during driving. Therefore, the fuel vapor discharged from the discharge port 54 to the external atmosphere can be driven away from the fuel tank lid 100 by the air flow. Thus, contact between fuel vapor and electronic elements of the drive circuit 400 is avoided.

The discharge port 54 is covered with the breathable filter 55. Therefore, liquid such as water is prevented from entering the hollow space of the storage part 12.

The lower closure part 16 and the side wall 14 are each made of a material having a fuel vapor permeability higher than the upper closure part 15 is. Therefore, fuel vapor can be discharged to the external atmosphere through the lower closure part 16 and the side wall 14.

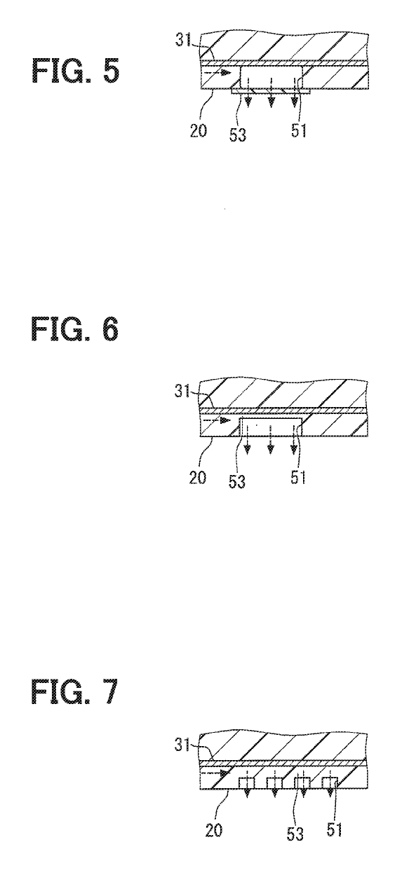

The present embodiment showed an example where the protection part 53 is made of an adhesive. The protection part 53 is not limited to the example. For example, as shown in FIG. 5, the protection part 53 may be a filter that allows permeation of gasses including the fuel vapor but not of liquids. Alternatively, as shown in FIG. 6 and FIG. 7, the protection part 53 may be made of the same resin material as that of the connection part 13. In this case, the protection part 53 has a smaller thickness in a portion where the protection part 53 covers the central portion 31 that is exposed from the lid part 10 than the thickness of the connection part 13 covering the internal terminal 30. In FIG. 6, one each of the first discharge part 51 and the protection part 53 are formed in the connection part 13, while, in FIG. 7, a plurality of first discharge parts 51 and a plurality of protection parts 53 are formed in the connection part 13. When the protection part 53 is made of the same resin material as that of the connection part 13, an increase in the number of components is avoided, as compared to the case where the protection part is made of a different material from that of the connection part.

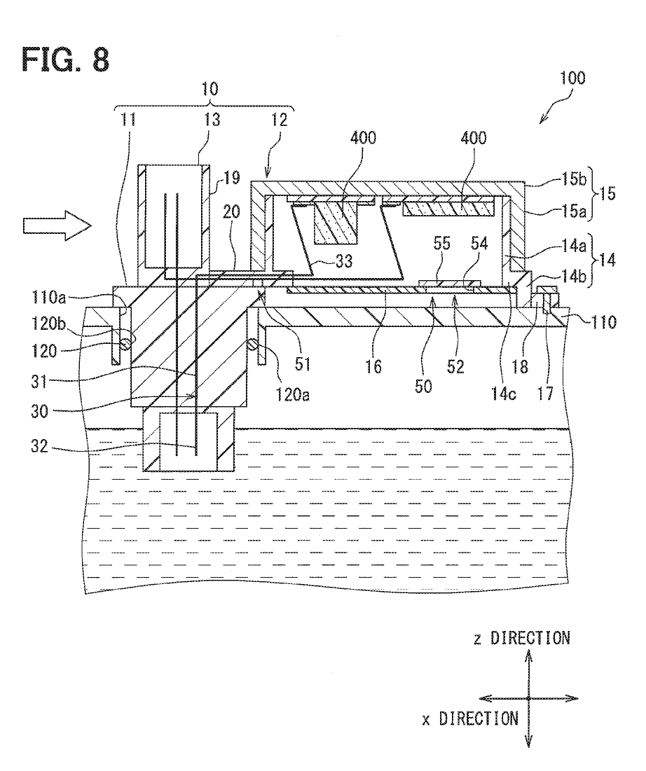

The present embodiment showed an example where the first discharge part 51 is located directly below the hollow space of the storage part 12 in the extension part 20, as shown in FIG. 2. However, the position of the first discharge part 51 is not limited to the example and may be anywhere as long as the first discharge part 51 can discharge fuel vapor that tries to travel along the interface between the internal terminal 30 and the lid part 10 and enter the hollow space of the storage part 12 to the external atmosphere. For example, as shown in FIG. 8, the first discharge part 51 in the extension part 20 may be positioned closer to the inserted part 11 than to the hollow space of the storage part 12.

### Second Embodiment

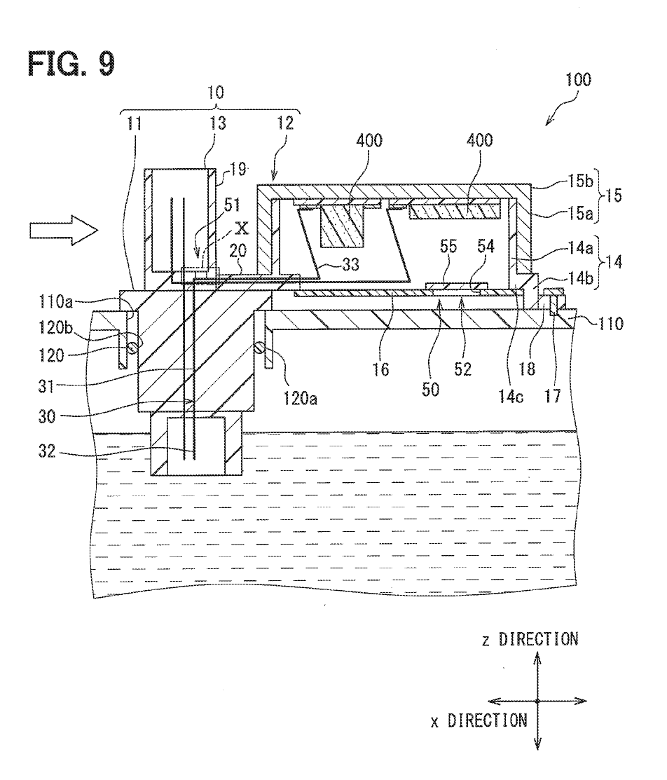

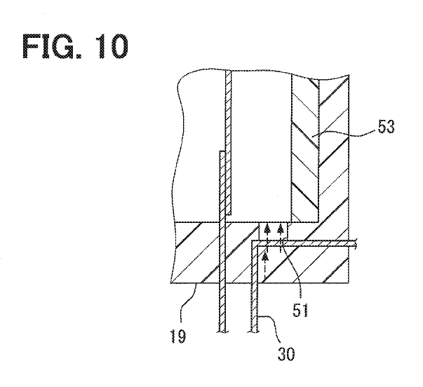

Hereinafter, a second embodiment of the present disclosure will be described with reference to FIG. 9 and FIG. 10. The fuel tank lid according to the second embodiment has much in common with the one according to the previously described embodiment. Therefore, the same parts will not be described again and different features will mainly be described below. Elements that are identical to the elements shown in the first embodiment described above are given the same reference numerals.

The first embodiment showed an example where the first discharge part 51 is formed in the extension part 20 of the connection part 13, and the first discharge part 51 is covered with the protection part 53 that is an adhesive. In the present embodiment, as shown in FIG. 9 and FIG. 10, the first discharge part 51 is formed in the bottom face of the tubular part 19 of the connection part 13, and the protection part 53 is a male connector, As the protection part 53 that is a male connector is fitted into the tubular part 19, the first discharge part 51 is separated from the external atmosphere. Therefore, the internal terminal 30 is prevented from being in contact with a liquid such as water through the first discharge part 51. By working out a good position for forming the first discharge part 51, an existing element (male connector of an external device) can be utilized as the protection part 53. Thus an increase in the number of components is avoided. Part of the male connector (protection part 53) is shown schematically in FIG. 10.

While preferred embodiments of the present disclosure have been described above, the present disclosure should not be interpreted to be limited to these embodiments, and can be variously modified without departing from the scope of the subject matter of the present disclosure.

The embodiments showed an example where the fuel tank lid 100 and the flange 110 are separate parts. However, the lid part 10 of the fuel tank lid 100 may be integral with the flange 110. In this case, the fuel tank lid 100 alone closes the opening 200a of the fuel tank 200 entirely.

While the fuel tank lid 100 has been mainly described in each embodiment, the present disclosure includes the fuel pump module 500 that includes the fuel tank lid 100, the fuel tank 200, the drive circuit 400, and the pump 300.

The embodiments showed an example where the inserted part 11, the connection part 13, and the side wall 14 are made of polyphenylene sulfide resin or polybutylene terephthalate resin. However, the resin material that forms the inserted part 11, the connection part 13, and the side wall 14 is not limited to the examples given above.

The embodiments showed an example where the second annular part 14b has a screw-fastened portion 18 such that the lid part 10 is fastened to the flange 110 with screws 17. However, the structure for fastening the lid part 10 to the flange 110 is not limited to the example given above.

The embodiments showed an example where all the electronic elements that form the drive circuit 400 are mounted on the upper closure part 15. An alternative configuration may be adopted, where, of the plurality of electronic elements forming the drive circuit 400, only those that are prone to deteriorate through contact with fuel vapor, in particular, are mounted on the upper closure part 15. Alternatively, all the electronic elements forming the drive circuit 400 may be mounted on the lower closure part 16 or the side wall 14 instead of the upper closure part 15.

The embodiments showed an example where the fuel tank lid 100 is exposed to the air flow created during driving. Alternatively, the fuel tank lid 100 may not be exposed to the air flow created during driving.

The embodiments showed an example where the discharge port 54 is arranged in the downwind of the air flow created during driving. Alternatively, the discharge port 54 may be arranged in the upwind of the air flow created during driving.

The embodiments showed an example where the discharge port 54 is covered with the breathable filter 55. Alternatively, the discharge port 54 may not be covered with the breathable filter 55.

The embodiments showed an example where the inserted part 11 and the connection part 13 are made of the same resin material. Alternatively, the connection part 13 may be made of a material that has a fuel vapor permeability higher than the inserted part 11 is. With this configuration, fuel vapor can be discharged to the external atmosphere not only through the first discharge part 51 but also through the connection part 13.

The embodiments showed an example where the connection part 13 is a female connector. The connection part 13 is not limited to the example given above and may have any shape as long as the connection part 13 connects the inserted part 11 and the storage part 12 and covers the internal terminal 30.

The embodiments showed an example where the discharge structure 50 includes the first discharge part 51 and the second discharge part 52. Alternatively, the discharge structure 50 may have only the first discharge part 51.

The embodiments showed an example where the first discharge part 51 is formed by the support pin 151 in the metal mold 150. The method of forming the first discharge part 51 is not limited to the example given above. For example, the first discharge part 51 can be formed by bringing a part of the central portion 31 of the internal terminal 30 into contact with an inner wall surface of the metal mold 150. Alternatively, the first discharge part 51 may be formed by grinding a part of the connection part 13.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A fuel tank lid comprising:
a lid part closing an opening of a fuel tank; and
an internal terminal electrically connecting a pump provided inside the fuel tank with a drive circuit driving the pump, wherein
the lid part includes
an inserted part inserted into the opening,
a storage part located outside the fuel tank and storing the drive circuit in a hollow space of the storage part, and
a connection part located outside the fuel tank and connecting the inserted part and the storage part, and
the internal terminal has a central portion, a first end, and a second end, the central portion being covered and protected by the inserted part, the connection part, and the storage part that are made of a resin material, the first end being connected to the pump inside the fuel tank, the second end being connected to the drive circuit inside the hollow space of the storage part,
the fuel tank lid further comprising a discharge part discharging a fuel vapor that tries to travel along an interface between the internal terminal and the lid part and enter the hollow space of the storage part, to an external atmosphere, the discharge part being formed in the connection part where thickness is locally reduced such that a portion of the central portion of the internal terminal is exposed from the lid part for discharging; and
the fuel tank lid further comprising a protection part covering the portion of the central portion of the internal terminal exposed from the lid part by the presence of the discharge part to protect the portion from a liquid.

2. The fuel tank lid according to claim 1, wherein
the protection part is made of a material having a fuel vapor permeability higher than a resin material forming the connection part.

3. The fuel tank lid according to claim 2, wherein
the protection part is an adhesive having high permeability of gasses including the fuel vapor but low permeability of liquids, and
the discharge part that is a recess is filled with the adhesive.

4. The fuel tank lid according to claim 2, wherein
the protection part is a filter having high permeability of gasses including the fuel vapor but low permeability of liquids.

5. The fuel tank lid according to claim 1, wherein
the protection part is made of a material same as a resin material forming the connection part, and
the protection part has a thickness in the portion of the central portion of the internal terminal exposed form the lid part smaller than a thickness of the connection part covering the internal terminal.

6. The fuel tank lid according to claim 1, wherein
the inserted part and the connection part are made of a resin material, and
the connection part is made of a material having a fuel vapor permeability higher than the inserted part.

7. The fuel tank lid according to claim 1, wherein
the connection part is a female connector case that receives a male connector of an external device,
the connection part has a tubular part surrounding the male connector and having a bottom face,
the tubular part has a cavity, into which the male connector is inserted, the cavity being separated from the external atmosphere when the male connector is fitted into the tubular part,
the discharge part is formed in the bottom face of the tubular part, and
the protection part is the male connector.

8. The fuel tank lid according to claim 1, further comprising:
a stopper member stopping a flow of the fuel vapor that tries to travel along an interface between the internal terminal and the lid part and enter the hollow space of the storage part, the stopper member being positioned closer to the storage part than to the discharge part in a portion of the central portion of the internal terminal.

9. The fuel tank lid according to claim 1, wherein
the internal terminal is insert-molded in the connection part such that a part of the central portion of the internal terminal is covered and protected by the connection part,
a metal mold that forms the connection part includes a support pin that fixedly holds the central portion of the internal terminal, and
the discharge part is formed by the support pin.

10. The fuel tank lid according to claim 1, wherein
the storage part includes a side wall that is in an annular shape and has two openings that are a first opening and a second opening, an upper closure part closing the first opening positioned vertically on an upper side of the second opening, and a lower closure part closing the second opening positioned vertically on a lower side of the first opening,
the drive circuit includes a plurality of electronic elements, and
at least one of the plurality of electronic elements is fixedly attached to the upper closure part so as to avoid from being in contact with the fuel vapor.

11. The fuel tank lid according to claim 10, wherein
the lower closure part has a discharge port that discharges the fuel vapor that has entered the hollow space of the storage part to the external atmosphere.

12. The fuel tank lid according to claim 11, further comprising:
a breathable filter that allows permeation of gasses including the fuel vapor but not of liquids, wherein
the discharge port is covered with the breathable filter.

13. A fuel pump module comprising:
the fuel tank lid according to claim 1;
a fuel tank having an opening closed by the fuel tank lid;
a drive circuit mounted on the fuel tank lid; and
a pump provided in the fuel tank and driven by the drive circuit.

14. The fuel pump module according to claim 13, wherein
the opening in the fuel tank is located vertically higher than walls forming the fuel tank.
